(19) United States
(12) Patent Application Publication
(10) Pub. No.: US 2003/0194499 A1
(43) Pub. Date: Oct. 16, 2003

(54) Application of imidazolidone-modified latexes to carbonyl-containing plastic substrates

(75) Inventors: Hui Shirley Yang, Plainsboro, NJ (US); Herve Adam, Princeton, NJ (US); Caroll Vergelati, Saint Baudille De La Tour (FR)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Rhodia, Inc.

(21) Appl. No.: 10/372,415

(22) Filed: Feb. 24, 2003

Related U.S. Application Data
(60) Provisional application No. 60/368,183, filed on Mar. 28, 2002.

(51) Int. Cl. B05D 3/02

(52) U.S. Cl. 427/385.5

(57) ABSTRACT

There is a method of coating a carbonyl-containing plastic substrate. The method has the step of applying to the substrate a paint having a latex polymer having imidazolidone monomeric content up to about 50 wt % based upon the weight of the latex polymer.

This application claims priority from U.S. Provisional Patent Application Serial No. 60/368,183, filed Mar. 28, 2002.

### BACKGROUND OF THE INVENTION

1. Field of the Invention

The invention relates to a method of coating a carbonyl-containing plastic substrate by applying to the substrate a paint having a latex polymer with imidazolidone monomeric content up to about 50 wt % based upon the weight of the latex polymer.

2. Description of the Prior Art

Latex paints have been employed as protective and decorative coatings for a variety of substrates. Latex paints are water-based emulsion polymer systems.

Since latex paints are water-based emulsion polymer systems, they are susceptible to moisture and humidity. Elevated levels of moisture and humidity are frequently encountered outdoors as well as indoors in kitchens and bathrooms. In such environments, latex paints may exhibit poor wet adhesion, i.e. poor adhesion to the substrate. Adhesion problems may be exacerbated if the substrate requires periodic or frequent washing or scrubbing.

The wet adhesion of latex paints has been improved by the inclusion of functional monomers, such as imidazolidones, in the latex polymers. Useful imidazolidones are shown, by way of example, in U.S. Pat. Nos. 4,111,877; 4,319,032; and 6,069,275.

One substrate variety, plastics, has proven particularly difficult to obtain adequate wet adhesion with latex paints. Carbonyl-containing plastics, such as nylon, polyethylene terephthalate (PET), polycarbonate, and polyurethane, have proven particularly difficult in this regard.

It would be desirable to have a method of coating carbonyl-containing plastic substrates with a latex paint. It would further be desirable to have a method of coating carbonyl-containing plastic substrates wherein excellent wet adhesion is obtained.

### SUMMARY OF THE INVENTION

It is an object of the present invention to provide a method for coating carbonyl-containing plastics with a latex paint.

It is an object of the present invention to provide a method for coating carbonyl-containing plastics with a latex paint that exhibits excellent wet adhesion.

According to this and other objects of the present invention, there is a method of coating a carbonyl-containing plastic substrate. The method has the step of applying to the substrate a paint having a latex polymer having imidazolidone monomeric content up to about 50 wt % based upon the weight of the latex polymer. The imidazolidone monomeric content is derived from an imidazolidone having the following formula:

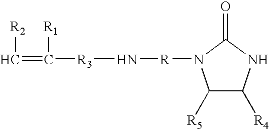

wherein R is CₘH₂ₘ and m is an integer from 1 to 10; wherein R₁ is a hydrogen atom or R; wherein R₂ is a hydrogen atom or R; wherein R₃ is a linear, cyclo or branched alkylene or alkoxylene, carbonyl, any other functional group or the combination of those groups; and wherein R₄ and R₅ are, independently, a hydrogen atom, linear, cyclo or branched alkylene or alkoxylene groups having from 1 to 24 carbon atoms.

### DETAIL DESCRIPTION OF THE INVENTION

It was found surprising and unexpected that a carbonyl-containing plastic substrate could be coated with a paint having a latex polymer having imidazolidone monomeric content. Such substrates have heretofore been very difficult to coat. The present invention is also surprising and unexpected in that carbonyl-containing plastic substrates could be coated.

Imidazolidones useful in forming latex polymers of the present invention can be represented by Formula I:

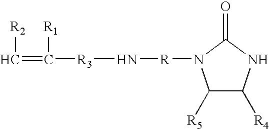

wherein R is CₘH₂ₘ and m is an integer from 1 to 10; wherein R₁ is a hydrogen atom or R; wherein R₂ is a hydrogen atom or R; wherein R₃ is a linear, cyclo or branched alkylene or alkoxylene, carbonyl, any other functional group or the combination of those groups; and wherein R4 and R₅ are, independently, a hydrogen atom, linear, cyclo or branched alkylene or alkoxylene groups having from 1 to 24 carbon atoms.

Preferred imidazolidone useful in forming latex polymers of the present invention can be represented by Formulas II, III, and IV:

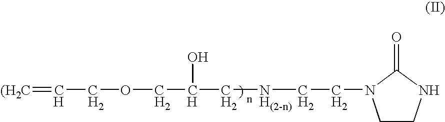

wherein “n” is from 1 to 2.

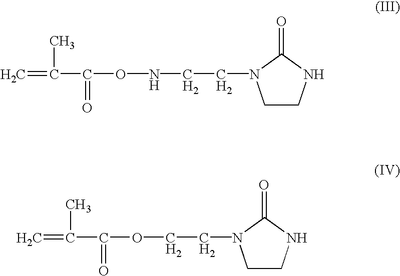

Commercially available imidazolidone monomers useful in forming the latex polymers are those known as SIPOMER WAM (Rhodia Inc.) shown in Formula II, SIPOMER WAM II (Rhodia Inc.) shown in Formula III, and WAM IV (Air Products and Chemicals, Inc.) shown in Formula IV. Other imidazolidone monomers useful are described in U.S. Pat. Nos. 4,111,877; 4,319,032; and 6,069,275. The foregoing patents are incorporated herein by reference.

The modified latexes are derived from copolymerization of the imidazolidone monomers and other monomers. They may be used to form emulsion polymers or solution polymers. Other monomers suitable for copolymerization with the imidazolidone monomers include the following: methyl acrylate, ethyl acrylate, methyl methacrylate, butyl acrylate, 2-ethyl hexyl acrylate, other acrylates, methacrylates and their blends, styrene, vinyl toluene, vinyl acetate, vinyl esters of higher carboxylic acids than acetic acid, acrylonitrile, acrylamide, vinyl chloride, and combinations thereof. Teachings to preparation of latexes are described in U.S. Pat. No. 6,300,410, which is incorporated herein by reference.

In particular, the reaction products and compounds of this invention may be incorporated in effective amounts in aqueous polymer systems to enhance the wet adhesion of paints made from the polymers. The commonly used monomers in making acrylic paints are butyl acrylate, methyl methacrylate, ethyl acrylate, styrene and mixtures thereof. In acrylic paint compositions at least 50% of the polymer formed is comprised of an ester of acrylic or methacrylic acid. The vinyl-acrylic paints usually include vinyl acetate and butyl acrylate or 2-ethyl hexyl acrylate. In vinyl-acrylic paint compositions, at least 50% of the polymer formed is comprised of vinyl acetate, with the remainder being selected from the esters of acrylic or methacrylic acid. In styrene-acrylic paints, at least 50% of the polymer formed is comprised of styrene, with the remainder being selected from the esters of acrylic or methacrylic acid.

The novel reaction products and compounds of this invention may be added to the monomer composition from which acrylic or vinyl-acrylic polymers are formed in a concentration that may vary over a wide range. Preferably, the concentration is at least sufficient to improve the wet adhesion of paints made from the polymer composition. Concentrations may range up to 50 wt %, preferably from about 0.5% to about 10%, and most preferably about 1.0 to about 5.0 wt % by weight based on the total weight of monomers. If desired, the modified latexes may also be blended with conventional or non-modified latexes. Such non-modified latexes can be formed from the various non-imidazolidone monomers disclosed in the foregoing paragraphs.

The monomer composition may be used in conjunction with other ingredients, such as various free radical sources to initiate polymerization, surfactants with or without colloids to protect particles from agglomeration, and buffers to maintain a desired pH during polymerization, all as known in the art of polymerization, and the polymerization may be carried out using conditions and techniques as are known in the art. In addition to making emulsion polymers, it is contemplated that the reaction products and compounds of the present invention be used to form solution copolymers.

In the present invention, the imidazolidone-modified latex can be applied to carbonyl-containing plastic substrates and exhibit excellent adhesion to those substrates. A carbonyl-containing plastic is a plastic that has a carbonyl moiety in its chemical structure. Useful carbonyl-containing plastic substrates include those of polyamides, polyethylene terephthalate, polycarbonates, and polyurethanes. Useful polyamides include nylon 6 and nylon 6,6. The modified latex can be applied in hot or cold weather and in low or high humidity. The modified latex can be applied with or without a primer having first been applied to the substrate to be painted.

The invention will now be illustrated by the following examples. The examples are not intended to be limiting of the scope of the present invention. In conjunction with the general and detailed descriptions above, the examples provide further understanding of the present invention. In the examples, percentages are by weight.

### EXAMPLES

Imidazolidone-modified latexes were prepared, formed into paints, which then are applied to carbonyl-containing plastic surfaces in accordance with the method of the present invention. The wet adhesion performance of paints having the modified latexes was compared to that of a paint having a non-modified latex, which was applied to the plastic surfaces as a control.

The non-modified latex was prepared according to the following procedure:

TABLE 1
Formulation for Non-Modified Latex (Control)

| Material | Weight (gm) | % BOTM |
|---|---|---|
| Kettle Charge | | |
| Deionized Water | 174 | |
| Monomer Emulsion | | |
| Deionized Water | 167.8 | |
| Rhodafac RS610 (30%, NH4⁺) | 41.7 | 2.5 |
| Methyl Methacrylate (MMA) | 260.0 | 52.0 |
| Butyl Acrylate (BA) | 235.0 | 47.0 |
| Methyl Acrylic Acid (MAA) | 5.0 | 1.0 |
| Oxidizer Solution | | |
| Deionized Water | 70.0 | |
| Sodium Persulfate | 2.0 | 0.4 |
| Reductant Solution | | |
| Deionized Water | 60.0 | |
| Sodium Metabisulfate | 1.5 | 0.3 |
| Total | 1017.9 | |

% BOTM = Weight percent based upon total monomer content

The latex is made according to the following procedure: 1) heat a kettle to −62° C. while purging with nitrogen; maintain a nitrogen blanket in the kettle headspace throughout the procedure; 2) add 4 wt % of the monomer emulsion to the kettle; wait 5 minutes for temperature to equilibrate; 3) add 12 grams of the oxidizer solution and 10 grams of the reductant solution to the kettle; hold the kettle charge at 62° C. for 15 minutes; 4) feed the remainder of the monomer emulsion and initiator solution to the kettle over 4 hours; maintain the reaction temperature of the kettle charge at 62° C. throughout the feeding process; hold the kettle charge (the latex) for 30 minutes after feeding is complete; 6) cool the latex and filter it through a 100 mesh polyester screen; adjust the pH of the latex to 9.0 (neutralized with ammonia).

Modified latexes were prepared in the same manner as the unmodified latex except that an imidazolidone monomer (WAM) was substituted for MMA in amounts corresponding to 1.2%, 1.8% and 2.4% BOTM. The WAM employed was SIPOMER WAM (Rhodia Inc.). The WAM was incorporated into the formulation via the reductant solution. The modified latexes had a mean average particle size of about 210 nm and a pH of 9.0 (neutralized with ammonia).

The modified and unmodified latexes were mixed with pigments to form white light industry type latex paints.

The paints were applied to substrates of nylon 6/6 and polyethylene terephthalate (PET), two carbonyl-containing plastics to test for wet adhesion. The tests were carried out according to ASTM D-3359, entitled “Standard Test Methods for Measuring Adhesion by Tape Test.” The results are set forth in Tables 2 and 3.

TABLE 2
Adhesion Test Results for 24 Hour Wet Adhesion

| | Control | Test Paint- | Test Paint- | Test Paint- |
|---|---|---|---|---|
| | Paint | 1 | 2 | 3 |
| Substrates | (% WAM) | (1.2% WAM) | (1.8% WAM) | (2.4% WAM) |
| Nylon 6,6 | 0B (0%) | 0B (0%) | 0B (0%) | 0B (0%) |
| PET | 0B (25%) | 3B (5%) | 4B (95%) | 5B (100%) |

TABLE 3
Adhesion Test Results for 24 Hour Recovery

| | Control | Test Paint- | Test Paint- | Test Paint- |
|---|---|---|---|---|
| | Paint | 1 | 2 | 3 |
| Substrates | (% WAM) | (1.2% WAM) | (1.8% WAM) | (2.4% WAM) |
| Nylon 6,6 | 0B (30%) | 4B (98%) | 5B (100%) | 5B (100%) |
| PET | 3B (85%) | 4B (95%) | 5B (100%) | 5B (100%) |

In the 24-hour wet adhesion test series, painted substrates were submerged underwater for 24 hours and tested for crosshatch adhesion. In the 24-hour recovery test series, painted substrates were removed from water, allowed to stand for 24 hours, then observed for blistering. Blistering was rated on a scale of 0B to 5B, with 5B indicating the greatest resistance to blistering. The amount of paint remaining on the substrate at the time of observation is indicated as a percentage of the original amount.

The results indicate that the WAM significantly improved wet adhesion, both with and without a recovery period. The proportion of paint remaining on the substrates was significantly greater for those having the modified latexes compared to the unmodified latexes.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A method of coating a carbonyl-containing plastic substrate, comprising: applying to the substrate a paint having a latex polymer having imidazolidone monomeric content up to about 50 wt % based upon the total weight of the latex polymer, the imidazolidone monomeric content being derived from an imidazolidone having the following structure: 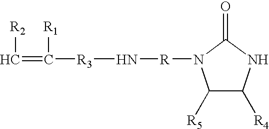
wherein r is CₘH₂ₘ and m is an integer from 1 to 10; wherein R₁ is a hydrogen atom or R; wherein R₂ is a hydrogen atom or R; wherein R₃ is a linear, cyclo or branched alkylene or alkoxylene, carbonyl, any other functional group or the combination of those groups; and wherein R₄ and R₅ are, independently, a hydrogen atom, linear, cyclo or branched alkylene or alkoxylene groups having from 1 to 24 carbon atoms.

2. The method of claim 1, wherein the imidazolidone monomeric content is from about 0.5 wt % to about 10 wt %.

3. The method of claim 1, wherein the imidazolidone monomeric content is from about 1.0 wt % to about 5.0 wt %.

4. The method of claim 1, wherein the carbonyl-containing plastic is a polyamide.

5. The method of claim 4, wherein the polyamide is nylon 6.

6. The method of claim 4, wherein the polyamide is nylon 6,6.

7. The method of claim 1, wherein the carbonyl-containing plastic is polyethylene terephthalate.

8. The method of claim 1, wherein the carbonyl-containing plastic is a polycarbonate.

9. The method of claim 1, wherein the carbonyl-containing plastic is a polyurethane.

10. The method of claim 1, wherein the imidazolidone monomeric content is from about 0.5 wt % to about 10 wt %, and wherein the carbonyl-containing plastic is selected from the group consisting of a polyamide, polyethylene terephthalate, a polycarbonate, and a polyurethane.

11. The method of claim 1, wherein the imidazolidone is represented by the following formula: 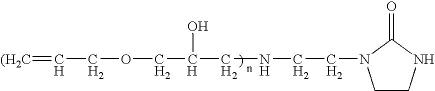
wherein n is from 1 to 2.

12. The method of claim 1, wherein the imidazolidone is represented by the following formula:

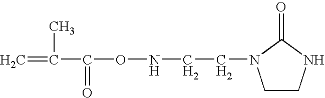

13. The method of claim 1, wherein the imidazolidone is represented by the following formula:

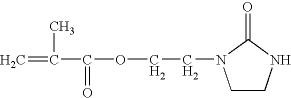

14. The method of claim 1, wherein the latex polymer is formed via copolymerization of the imidazolidone monomer and another monomer selected from the group consisting of methyl acrylate, ethyl acrylate, methyl methacrylate, butyl acrylate, 2-ethyl hexyl acrylate, other acrylates, styrene, vinyl toluene, vinyl acetate, vinyl esters of higher carboxylic acids than acetic acid, acrylonitrile, acrylamide, vinyl chloride, and combinations thereof.

15. The method of claim 1, wherein the latex polymer is formed via copolymerization of the imidazolidone monomer and vinyl acetate monomer.
